(19) United States
(12) Patent Application Publication
(10) Pub. No.: US 2010/0255856 A1
(43) Pub. Date: Oct. 7, 2010

(54) Location Sensing Selection for Mobile Devices

(75) Inventors: Aman Kansal, Issaquah, WA (US); Dimitrios Lymberopoulos, Redmond, WA (US); Feng Zhao, Issaquah, WA (US); Kaisen Lin, Cupertino, CA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/417,752

(22) Filed: Apr. 3, 2009

(51) Int. Cl. H04W 24/00

(52) U.S. Cl. 455/456.1

(57) ABSTRACT

Disclosed herein are one or more embodiments that determine, for a mobile device, an accuracy constraint associated with at least one location query. One or more of the described embodiments may further select, for the mobile device, a location sensing modality of one or more location sensing modalities, each of the one or more location sensing modalities being associated with an energy consumption characterization, and the selecting being based at least in part on the accuracy constraint and on the energy consumption characterizations of the one or more location sensing modalities.

### BACKGROUND

In recent years, mobile devices, such as cellular phones, personal digital assistants (PDAs), and media players have advanced from offering basic telephony to offering a much richer array of services to their users. A typical mobile device now offers voice communication, multiple forms of data communication (e.g., email, short message service (SMS), multimedia messaging service (MMS), and/or instant messaging), calendaring, contact lists, Internet browsing, games, and numerous other applications.

Many current and potential mobile device based services and applications and other mobile device features require a current mobile device location in order to provide the desired functionality. For example, a restaurant application might suggest nearby restaurants based on the current mobile device location. To determine its current location, a mobile device typically relies on its global positioning system (GPS) receiver to communicate with GPS satellites and obtain its location. Mobile devices can also obtain their locations through other location sensors, such as sensors communicating with WiFi Access Points, nearby Bluetooth™ devices, and cell towers. Each of these sensors provides a mobile device location with a varying degree of accuracy. For example, the GPS sensors typically provide more accurate location information than other sensor types. However, the accuracy may also depend on the situation or context. For example, although GPS sensors typically provide more accurate mobile device locations, GPS may in fact provide less accuracy if used within a building. Additionally, each of these sensors consumes a different amount of battery power. GPS sensors typically consume a large amount of energy, while inferring location from cell tower connectivity consumes almost no energy at all.

Further, different applications often require differing degrees of accuracy. For example, an application displaying nearby airports might not need to know the mobile device location with the same degree of precision as an application displaying nearby restaurants.

### SUMMARY

Techniques for selecting which location sensors to use when locating a mobile device are described. In particular, selection of a location sensor is based on a function of the accuracy desired for a particular application and energy conservation. More specifically, in various embodiments, a mobile device is configured to determine an accuracy constraint associated with a location query received from an application of the mobile device or some other source. The mobile device then selects a location sensing modality from a number of location sensing modalities, each location sensing modality associated with a location sensor. Additionally, each of the location sensing modalities is associated with a characterization of its energy-consumption. Further, the mobile device performs the selection based at least partially on the accuracy constraint and on the energy-consumption characterization.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF DRAWINGS

Non-limiting and non-exhaustive examples are described with reference to the following figures. In the figures, the left-most digit(s) of a reference number identifies the Fig. in which the reference number first appears. The use of the same reference numbers in different figures indicates similar or identical items or features.

FIG. 1 illustrates an example architecture in which location sensing modality selection is implemented.

FIGS. 2-4 illustrate example displays of mobile device locations.

FIG. 5 is a block diagram of selected modules in an example mobile device configured to select a location sensing modality.

FIG. 6 illustrates an example location sensing modality selection framework for implementation in modules and data of a mobile device and/or server(s).

FIG. 7 is a flowchart view of example operations of a location sensing modality selection process.

FIG. 8 is a flowchart view of example operations of a location estimation process.

FIG. 9 is a flowchart view of example operations of an accuracy constraint determination process.

### DETAILED DESCRIPTION

This disclosure describes selection of location sensing modalities for a mobile device based on a function of the accuracy desired and the energy expense of using different location sensing modalities. Mobile devices are often equipped with many location sensing capabilities, such as GPS, Bluetooth™, WiFi, cellular, and so forth. Each of these have varying degrees of accuracy for locating the mobile device at a specific geographic location, and each of these consume varying levels of power. The techniques described below select location sensing modality corresponding to a location sensor that provides a sufficient degree of accuracy for locating the mobile device for a given context or application, while otherwise minimizing the energy consumed. Thus, for example, if an application generally needs to locate a mobile device within a few hundred feet, the system determines which of the possible location sensing modalities meets this requirement, and then, from among the available location sensing modalities, selects the location sensing modality which offers the best performance in terms of power conservation.

### Example Architecture

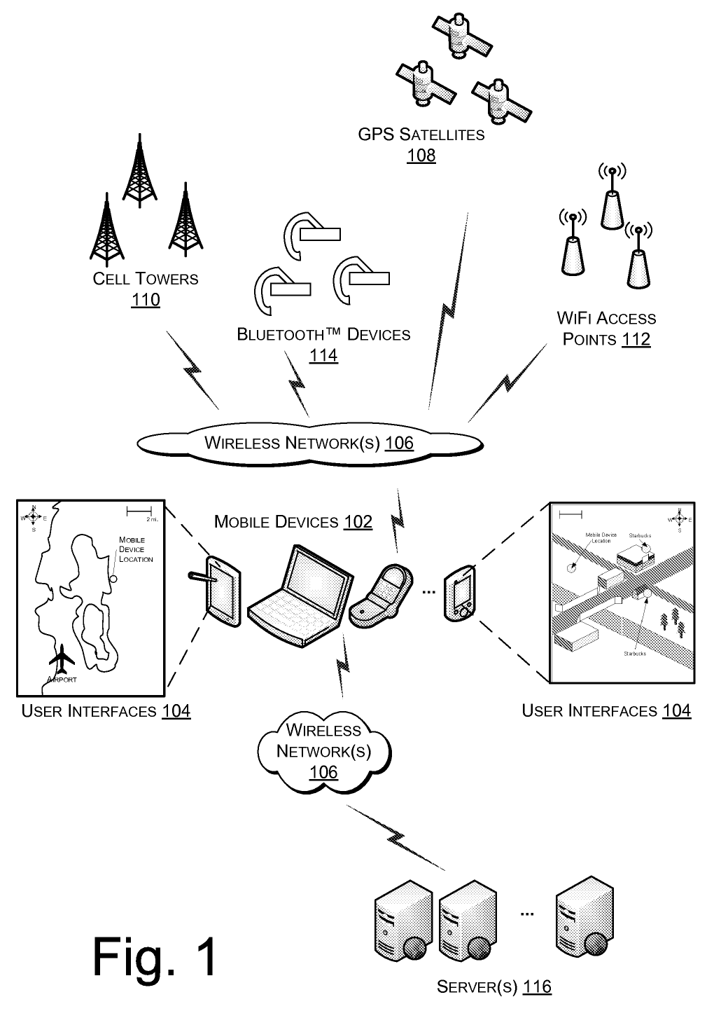

FIG. 1 illustrates an example architecture 100 in which location sensing modality selection is implemented. As illustrated, the architecture includes one or more mobile devices 102 having applications capable of rendering user interfaces 104. The mobile devices 102 are also configured to communicate via wireless network(s) 106 with any or all of GPS satellites 108, cell towers 110, WiFi access points 112, and/or Bluetooth™ devices 114. The mobile devices 102 are further configured to communicate via wireless network(s) 106 with one or more server(s) 116.

In various embodiments, the mobile devices 102 are any sort of mobile devices known in the art, such as cellular phones, PDAs, media players, or laptops. The applications of the mobile devices 102 query the mobile devices 102 for their locations. The applications may then display those returned locations on one or more user interfaces 104 of the applications or use the location information to provide other services. In some embodiments, the differing applications and their user interfaces 104 may require differing degrees of accuracy for the locations of the mobile devices 102.

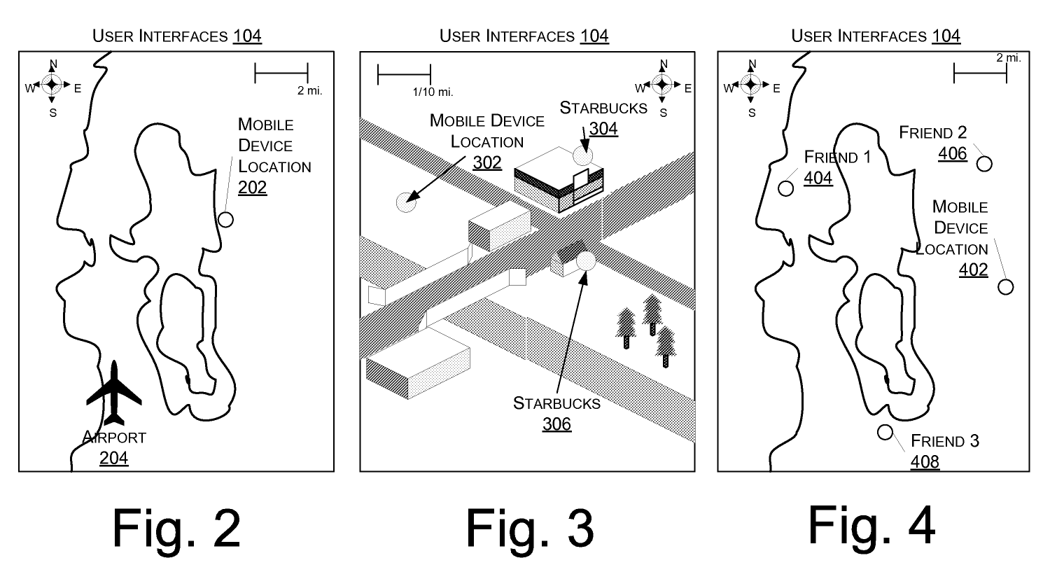

FIGS. 2-4, for example, show three application user interfaces 104 displaying the location of the mobile device 102. In FIG. 2, an application has a user interface 104 for displaying the location 202 of the mobile device 102 on a map in relation to nearby airports 204. Because there are unlikely to be many airports 204 in close proximity to each other, this application requires only an approximate mobile device location 202 (e.g., within a one mile radius). In FIG. 3, in contrast, another application has a user interface 104 for displaying the location 302 of the mobile device 102 on a map in relation to nearby Starbucks coffee shops 304 and 306. Because there are likely to be many Starbucks coffee shops 304/306 in close proximity to each other, the application requires a mobile device location 302 to be accurate within a few hundred meters. In FIG. 4, a social networking application has a user interface 104 for displaying the location 402 of the mobile device 102 on a map in relation to nearby social network friends 404, 406, and 408 of the mobile device user. The accuracy required by the social networking application varies from one moment in time to another based how close the locations 404-408 of the friends are to each other and to the mobile device 102. The determining of an accuracy requirement that varies with time and location is discussed further below.

In some embodiments, the actual mobile device location is the same, despite being shown as differing in FIGS. 2 and 4. The apparent difference in position of the mobile device 102 between FIGS. 2 and 4 is explained based on the location sensor selected to obtain the locations shown in those figures and on the differing accuracies of those location sensors.

Referring again to FIG. 1, to obtain mobile device locations meeting the required accuracies for applications, the mobile devices 102 select among a plurality of location sensing modalities associated with location sensors of the mobile devices 102. For example, a mobile device 102 may have four location sensors, each configured to obtain a location from one of the GPS satellites 108, the cell towers 110, the WiFi access points 112, and the Bluetooth™ devices 114. Each locations sensor is in turn associated with an accuracy and energy consumption characterization, both of which may vary from location to location.

In some embodiments, to select a location sensing modality, a mobile device 102 first estimates the location of the mobile device 102. The mobile device 102 then determines the location sensing modalities available at the estimated location, as well as the accuracies and energy consumption characterizations associated with each available location sensing modality at the estimated location. The mobile device 102 then determines which of the available location sensing modalities have accuracies which meet or exceed the accuracies required by the applications. From among these, then, the mobile device 102 selects the location sensing modality which consumes the least energy. In some embodiments, the mobile device 102 utilizes the location sensor associated with the selected location sensing modality to obtain its location and provide that location to querying application(s) for display on the user interface(s) 104.

As illustrated in FIG. 1, the location sensors of the mobile devices 102 obtain the mobile device locations by communicating via the wireless network(s) 106 with any or all of GPS satellites 108, cell towers 110, WiFi access points 112, and/or Bluetooth™ devices 114. In some embodiments, the wireless network(s) include one or more public and/or private networks, such as cellular networks, private data networks, public data networks, and the Internet. The one or more networks also include local area networks (LANs), wide area networks (WANs), and/or Bluetooth™ networks. GPS satellites 108, cell towers 110, WiFi access points 112, and Bluetooth™ devices 114 are any such devices known in the art. In other embodiments, mobile device 102 also includes other location sensors which are associated with other means of obtaining a mobile device location.

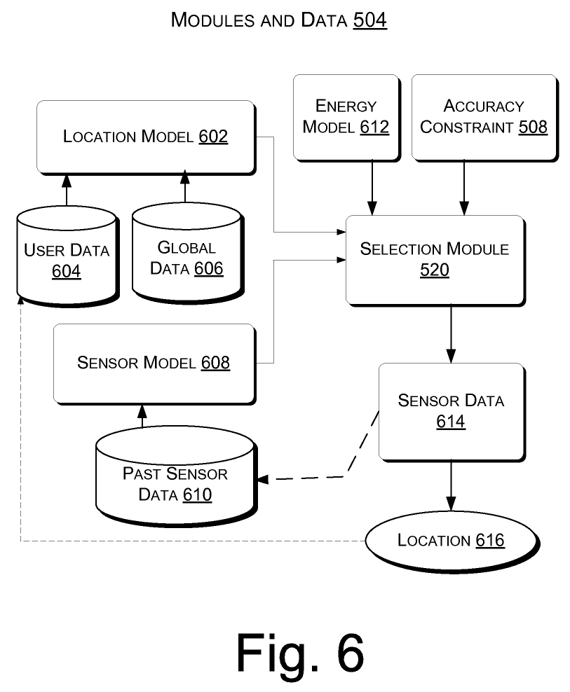

As is further illustrated, the mobile devices 102 further communicate with one or more servers 116 via the wireless network(s) 106. The servers 116 are any sort of computing devices, such as personal computers (PCs), laptops, servers, mainframes, phones, personal digital assistants (PDAs), set-top boxes, and data centers. In various embodiments, the servers 116 include any, some, or all of the modules and data implemented on the mobile devices 102 and remotely perform the above-described operations of the mobile devices 102 on behalf of the mobile devices 102. An example framework, any portion of which is implemented on either the mobile devices 102 or servers 116, is shown in FIG. 6 and described in greater detail below in reference to that figure.

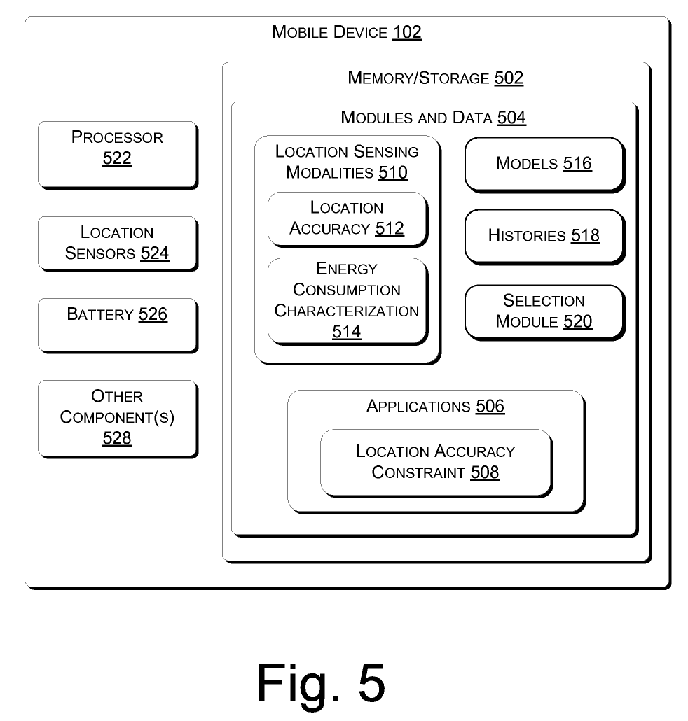

Mobile devices 102 are also illustrated in FIG. 5 and are described in greater detail below in reference to that figure.

### Example Mobile Device

FIG. 5 illustrates example components, modules, and data in the mobile device 102 of FIG. 1, which implement location sensing modality selection. As illustrated, a mobile device 102 includes a memory/storage device 502, which may store modules and data 504. Modules and data 504 in turn include application(s) 506 and their associated accuracy constraints 508, location sensing modalities 510 and their accuracies 512 and energy consumption characterizations 514, as well as models 516, histories 518, and a selection module 520. The mobile device 102 also includes a processor 522, location sensors 524, a battery 526, and, optionally, one or more other components 528.

In some embodiments, memory/storage 502 includes one or more of a system memory, removable storage, and/or non-removable storage. Such system memory is volatile (e.g., RAM), non-volatile (e.g., ROM, flash memory, etc.), or some combination of the two. Thus, memory/storage 502 includes volatile and nonvolatile, removable and non-removable media implemented in any method or technology for storage of information, such as computer readable instructions, data structures, program modules, or other data. System memory, removable storage, and non-removable storage are all examples of computer storage media. Memory/storage 502 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by mobile device 102.

In various embodiments, the applications 506 of modules and data 504 are any sort of applications known in the art, such as restaurant recommendation applications, airport finders, navigation applications, and social networking applications, among many others.

As mentioned above, each of these applications 506 may require a different level of accuracy. These accuracy requirements are represented by the accuracy constraints 508. In various embodiments, modules and data 504 receive the accuracy constraint 508 via an application 506 or calculate the accuracy constraint 508 for an application 506. To calculate the accuracy constraint 508, modules and data 504 rely on an estimated mobile device location as well as locations of one or more other entities of interest specified by a location query received from the application 506. In some embodiments, the locations of the one or more other entities is received or retrieved from a server 116 prior to calculating the accuracy constraint 508. The calculation of the accuracy constraint 508 is also shown in FIGS. 6 and 9 and described below in reference to those figures.

In various embodiments, the location sensing modalities 510 are any sort of modules and data associated with a location sensor 524. In various embodiments, location sensing modalities 510 provide an interface between other portions of modules and data 504, such as selection algorithm 520 and applications 506, and the location sensors 524. Additionally, location sensing modalities 510 also store information about a location sensor 524, such as the accuracy 512 and/or energy consumption characterization (s) 514 associated with the location sensor 524.

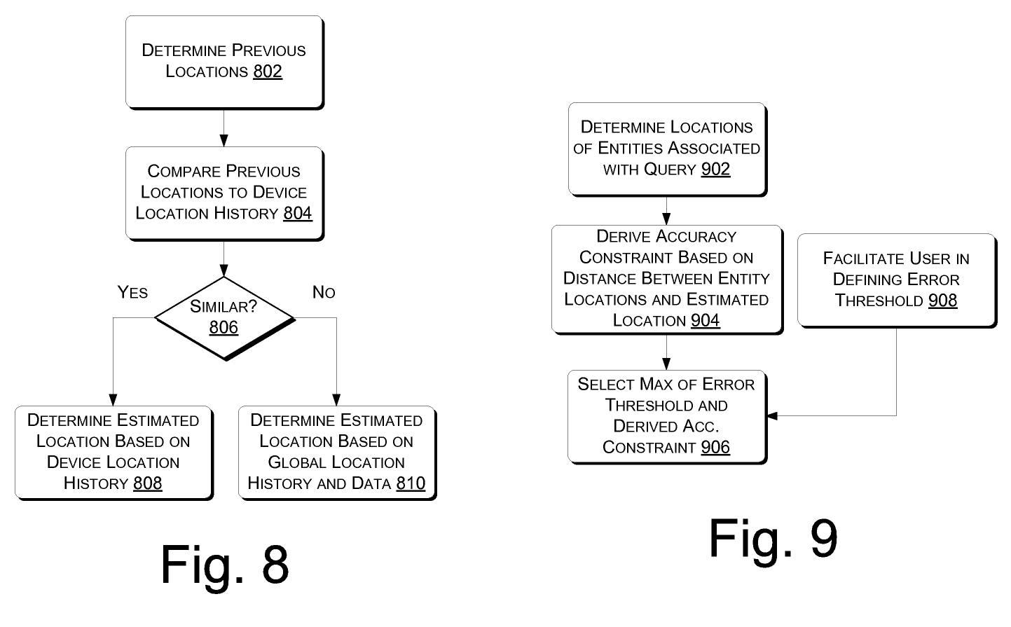

The location accuracy 512 is a static value, a range of values, or a dynamic value that varies from location to location. For example, the location accuracy 512 associated with a GPS location sensing modality 510 may vary based on whether the mobile device 102 is in a building or outside. Thus, in selecting a location sensing modality 510, modules and data 504 first calculate an estimated mobile device location in order to determine the location accuracies 512 of the location sensing modalities 510. The calculation of the estimated location is shown in FIGS. 6 and 8 and described below in reference to those figures.

In some embodiments, the energy consumption characterization 514 represents a value, range of values, or a trend related to consumption of battery power by a location sensor 524 when the location sensor 524 is used to obtain a mobile device location. The energy consumption characterization 514 may vary from location to location or may be relatively static. For example, the battery power consumed by a Bluetooth™ location sensor 524 varies based on the number of nearby Bluetooth™ devices 114. Thus, in order to determine the energy consumption characterization 514, modules and data 504 first calculates an estimated mobile device location.

In various embodiments, the accuracy 512 and energy consumption characterization (s) 514 are calculated by modules and data 504 based on a sensor model 608 and/or on an energy model 612, as shown in FIG. 6 and described below.

In some embodiments, location sensing modalities 510 process sensor data retrieved by a location sensor 524 to determine a location. For example, if the location sensor 524 is a WiFi radio which determines access point identifiers of a plurality of local access points, the location sensing modality 510 associated with the WiFi radio determines locations of the access points based on their identifiers by retrieving the locations from local or remote storage. In one embodiment, the location sensing modality 510 then triangulates between the multiple WiFi access point locations to determine the mobile device location. In another embodiment, the list of visible access points is sent to a database that contains lists of visible access points and likely locations corresponding to those lists. That database may then return the likely location for this mobile device based on the visible access point list received.

As illustrated, modules and data 504 further includes models 516, histories 518, and a selection module 520. Models 516, histories 518, and selection module 520 are described in greater detail below in reference to FIG. 6.

In various embodiments, processor 522 is any sort of processor or group of processors known in the art. In addition to a physical processor, processor 522 may also include one or more virtual processors of one or more virtual machines.

As illustrated, location sensors 524 refer to a wide collection of components capable of ascertaining a mobile device location. In some embodiments, locations sensors 524 include a GPS receiver that is capable of communicating with one or more GPS satellites 108 to obtain the mobile device location. Additionally, location sensors 524 also or instead include a WiFi radio that is capable of communicating with one or more WiFi access points 112 to scan for access point identifiers of the WiFi access points 112, which are then used to triangulate a mobile device location. The triangulation may be based on signal strength, time of flight, or simply a database lookup that converts lists of visible access points to likely locations. In some embodiments, location sensors 524 also or instead include components capable of scanning for nearby Bluetooth™ devices 114 and communicating with the Bluetooth™ devices 114 to ascertain their locations, if known. In further embodiments, location sensors 524 also or instead comprise components, such as a radio receiver capable of interacting with cell towers 110 and determining and storing a list of visible cell towers 110, which are then used to triangulate a mobile device location. Also, in addition to the location sensors 524 described above, location sensors 524 may further include components capable of ascertaining a mobile device location based on image capture, voice recognition, or any other mechanism known in the art.

In various embodiments, battery 526 is any sort of mobile device battery known in the art. For example, battery 526 may be a nickel metal-hydride battery, a lithium-ion (li-on) battery, a lithium-polymer battery, a solar cell battery, or any other type of light-weight battery known in the art.

In some embodiments, mobile device 102 optionally contains other components 528. The other components 528 are any components known in the art that may be incorporated in a mobile device 102. For example, mobile device 102 may include a subscriber information module (SIM) card, input device(s) such as keyboard, voice input device, touch input device, etc., output device(s) such as a display, speakers, etc., and a transceiver for engaging in cellular and/or wireless data communication. These other components 528 are well known in the art and need not be discussed at length here.

### Example Framework

FIG. 6 illustrates an example location sensing modality selection framework for implementation in modules and data of a mobile device and/or server(s), in accordance with various embodiments. As illustrated, modules and data 504 implement any or all portions of a framework which includes a location model 602, user data 604, global data 606, a sensor model 608, past sensor data 610, an energy model 612, an accuracy constraint 508, a selection module 520, sensor data 614, and a location 616.

### Location Model 602

In various embodiments, the location model 602 helps calculate an estimated location of the mobile device 102. To calculate the estimated location, the location model 602 utilizes a history 208, such as past user data 604, which illustrates a mobile device 102's motion trajectory as well as include historic data about the mobile device's behavior. For example, user data 604 may show that, during the last two location measurements, the mobile device 102 has arrived at a New York City airport and gotten into a cab. The user data 604 may also show that at the same day and time last week, the user was in Bellevue, Wash.

In addition to the user data 604, the location model 602 may make use of global data 606 in calculating the estimated location. The global data 606 includes probability densities where mobile device users are likely to be, as well as historic data, such as previous locations and trajectories of other mobile devices. Continuing with the above example, global data 606 may show that a user taking a taxi from a New York City airport is most likely to go to Times Square. In calculating the estimated location, the location model 602 might rely on the global data 606 to estimate Times Square as the mobile device location, even though the user data 604 suggests that, historically, the mobile device 102 would be commuting to Issaquah, Wash., on that day and time. In determining whether to rely on the global data 606 or the history stored by the user data 604, the location model 602 relies on the most recent measured locations (i.e., the location trajectory) of the mobile device 102. If the trajectory is similar to a previous trajectory at, for example, a previous date and time, the location model 602 relies on the user data 604. If, however, the trajectories differ, then the location model 602 instead relies on the global data 606.

In relying on the most recent measured locations, the location model 602 utilizes a second order Hidden Markov Model (HMM). The HMM may use the past two estimated locations to yield a probability distribution of the predicted location x at a time t, where the probability distribution is defined as p(x(t)|x(t−1), x(t−2)). Using the HMM allows the location model 602 to take the current direction/trajectory of the mobile device 102 motion into account by providing transition probabilities between locations.

In addition to probability densities and location histories of other mobile devices, global data 606 also includes information such as land-use patterns to account for the fact that a mobile device 102 is more likely to be on land than on a body of water.

In some embodiments, location model 602 calculates a probability distribution for the estimated location, indicating multiple estimated locations and the probabilities of each. To calculate the distribution, location model 602 selects, randomly or otherwise, a number of locations x discretized at a given time t (represented as x(t)), that takes values in a two dimensional space denoted by X. Further, a location observation made using a location sensing modality i at time t is represented as zᵢ(t), where i is selected from a set L of all available location sensing modalities 510. Further, a vector z̅(̅t̅)̅ represents all observations made up to t (i.e., z̅(̅t̅)̅={z(t), z(t−1), . . . , z (0)} for any i). Then, a probability distribution for the estimate location given all previously made observations z and prior models is represented by p(x| z̅(̅t̅−̅1̅)̅). Given the probability distribution, the location model 602 then selects the location x having the highest probability as the estimated location.

In various embodiments, instead of or in addition to calculating the probability distribution, the location model 602 utilizes other techniques for calculating the estimated location, such as Kalman filters or conditional random fields. These techniques are well known in the art and, accordingly, will not be described further.

These location estimation operations are further illustrated in FIG. 8 and described in greater detail below in reference to that figure.

### Sensor Model 608

In various embodiments, the sensor model 608 characterizes the accuracy/quality 512 of location information that a location sensing modality 510 offers at a given location, and indicate which given location sensing modalities 510 are available at the given location. GPS location sensors 524, for example, are more accurate outdoors than in a building. WiFi, Bluetooth™, and cell-tower location sensors 524, on the other hand, are more accurate when more WiFi access points 112, Bluetooth™ devices 114, and cell towers 110, respectively, are visible to the mobile device 102.

In some embodiments, the sensor model 608 is accumulated based on past sensor data 610 resulting from past measurements at each location by the mobile device 102 and/or by other devices. Likelihoods that the measured locations match the true locations are obtained from the past sensor data 610 using a probability distribution which takes into account a standard deviation between a sensed mobile device location and a true location of the mobile device 102. To calculate the probability distribution, the sensor model 608 defines the probabilities as p(zᵢ(t)|x(t)), which represent the likelihood of a location sensing modality i yielding the location measurement zᵢ(t) at time t when the true location is x(t). The distribution p( ) may then further be defined as:

$$p ( {z}_{i} ( t ) \vert x ( t ) ) = \frac{1}{\sqrt{2 π} {σ}_{x ( t )}} exp ( \frac{{( {z}_{i} ( t ) - x ( t ) )}^{2}}{2 {σ}_{x ( t )}^{2}} )$$

where σₓ₍ₜ₎ represents the standard deviation for a location sensor 524 at a location x(t). In some embodiments, the standard deviation is a constant value, such σₓ₍ₜ₎=1.2 at locations x(t) where GPS is available and σₓ₍ₜ₎=infinity at locations x(t) where GPS is unavailable. Bluetooth™ also uses a constant value, based on the Bluetooth™ device range. In other embodiments, the standard deviation is a function of some other metric. For example, for a WiFi location sensor 524, the standard deviation is a function of the number of access points visible at x(t). Cell-tower location sensors 524 may have their standard deviation calculated based on the cell size.

In various embodiments, past sensor data 610 includes not only measured locations zᵢ(t), but also information such as the number of visible access points 112 for WiFi and/or the cell size associated with a cell tower 110, and/or the location observed using other location sensing modalities at the same time (t). Using this information, and using the estimated location as x(t), the sensor model 608 calculates the probability distribution p( ) to determine the likelihood of observing location zᵢ(t) when the true location is x(t) for the available location sensing modalities 510.

### Energy Model 612

In various embodiments, the energy model 612 represents the energy/battery 526 power consumed by a location sensor 524 to obtain a location. This energy consumed is the energy consumption characterization 514 associated with the location sensing modality 510 associated with the location sensor 524 that was used. In some embodiments, such as when the location sensors used include a WiFi location sensor 524 or cell-tower location sensor 524, the energy consumed is the same at each location for those sensors, and the energy consumption characterization 514 is simply a value indicative of this consumption. In various embodiments, such as when the location sensors 524 used include a Bluetooth™ location sensor 524 or a GPS location sensor 524, the energy consumed varies from location to location. With a Bluetooth™ location sensor 524, the energy consumed varies based on the number of Bluetooth™ devices 114 visible to the mobile device 102. With a GPS location sensor 524, the energy consumed varies based on whether the location sensor 524 has a clear view of the sky (i.e., is not in a building, etc.). To account for the varying energy consumptions, energy model 612 stores a location-based index (potentially learned from history of measurements) of energy consumed at various locations by the location sensor 524. In such embodiments, the energy consumption characterization 514 represents a range or trend of values.

In some embodiments, the energy consumptions represented by the energy model 612 are pre-determined experimentally and stored in the energy model 612. In other embodiments, the energy consumptions are measured each time location sensors 524 are used and accumulated in the energy model 612. In yet other embodiments, some combination of both techniques is used to build the energy model 612.

### Accuracy Constraint 508

As mentioned above, the mobile device 102 receives one or more location queries. These location queries are each associated with an accuracy constraint 508 and are posed by application(s) 506. For example, a social networking application 506 queries for the mobile device location to display that location on a map with the locations of friends of the user of the mobile device 102, as shown in FIG. 5. Another application 506 also seeks the mobile device location to display it alongside the locations of a few nearest local airports or restaurants (see FIGS. 3 and 4). Each of these applications 506 requires a different accuracy. For example, an application 506 displaying local restaurants may need to know the mobile device location with greater accuracy than an application 506 displaying local airport(s). The accuracy required by each application 506, then, is associated with an accuracy constraint 508 measured in, for example, a unit of distance. In some embodiments, each application 506 maintains its accuracy constraint 508 and provides it when posing a location query.

In other embodiments, the accuracy constraint 508 for an application 506 is calculated dynamically in response to the posing of a location query by the application 506. Such calculation is useful for an application 506 with varying accuracy needs. For example, an application 506 capable of displaying restaurants requires greater accuracy with respect to the mobile device 102's location in an urban area than in a rural area.

To calculate the accuracy constraint 508, the modules and data 506 first ascertain the estimated location determined by the location model 602 and locations of one or more entities associated with the location query. For example, if the location query is posed by a restaurant application 506, the one or more entities may be restaurants. If the location query is posed by a social networking application 506, the one or more entities may be friends. In various embodiments, these entity locations are cached in advance when arriving at an area, are looked up in a yellow pages stored locally or remotely, or are determined by the application 506 in some other fashion. In ascertaining entity locations, the modules and data 504 selects the k closest entities to the estimated location.

After ascertaining the estimated location and the locations of the k closest entities, the modules and data 504 calculates the accuracy constraint 508. In some embodiments, this calculated accuracy constraint 508 is a maximum tolerable location error, represented as eᵣ(t), denoting the maximum tolerable location error at time t. That maximum tolerable location error is defined as:

$${e}_{r} ( t ) \leq max \{ \begin{matrix}{r}_{k + 1} - {r}_{k} \\ 2\end{matrix} , Δ ( t ) \}$$

where r represents a radius of a circle between a location of an entity k or k+1 and an estimated mobile device location, and Δ(t) represents a threshold on the smallest tolerable error that may be requested by an application 506. Thus, if the nearest k entities are a large distance from each other, the difference between the r values will be relatively large, and so will the maximum tolerable error. If, however, the nearest k entities are near each other, the maximum tolerable error will be relatively small.

In various embodiments, Δ(t) may be a pre-determined value that is the same for all applications 506 or that varies for application 506 to application 506. In some embodiments, Δ(t) is based on the highest accuracy available from any location sensor 524. In yet other embodiments, Δ(t) is set by a user based on a user's preferences. For example, if the mobile device user is part of a social network and provides a location to friends, the user may not want friends to be able to ascertain his or her location with a high degree of accuracy, such as to preserve privacy. By increasing the threshold Δ(t), then, the user decreases the accuracy required and provides friends with a less precise location than could otherwise be determined.

These accuracy constraint determination operations are further illustrated in FIG. 9 and described in greater detail below in reference to that figure.

### Selection Module 520

In various embodiments, the selection module 520 selects a location sensing modality 510 that will consume the least battery power but still satisfy the accuracy constraint 508. To select the location sensing modality 510, the selection module 520 first determines which location sensing modalities 510 are available at the estimated location. The selection module makes this determination with reference to the sensor model 608 based on the probability distribution calculated by the sensor model 608. After creating a list of the available location sensing modalities 510, the selection module 520 determines a variance of each location sensing modality 510 (the variance being the square of the error for each location sensing modality), the variance serving as a measure of accuracy 512 of each location sensing modality 510. In some embodiments, the selection module 520 then compares the variances to the square of the accuracy constraint 508. Based on the results of the comparison, the selection module 520 creates a shortlist of the location sensing modalities 510 whose variance is less than the square of the accuracy constraint 508. The selection module 520 then determines the energy consumption characterization 514 for each location sensing modality 510 on the shortlist, with reference to the energy model 612, and selects the location sensing modality 510 associated with the energy consumption characterization 514 which indicates the least energy consumption.

In various embodiments, to calculate the variance for each location sensing modality 510, the selection module 520 first determines a posterior probability distribution p(x(t)|zᵢ(t)), where x(t) is the true location of the mobile device 102 at time t, and zᵢ(t) is the observed location of the mobile device 102 at time t using location sensing modality i. Using the distribution, the selection module 520 computes a variance of (x(t)|zᵢ(t)) and takes this variance as an estimate of the error for a location sensing modality i at time t. This variance is then denoted as eᵢ(t), and eᵢ(t) may be defined as:

eᵢ(t)=Var(x(t)|zᵢ(t))=E[(x(t)−E[x(t)|zᵢ(t)])²|zᵢ(t)]

The posterior probability distribution itself is computed using the location model 602 and sensor model 608, using the following Bayes rule for a given zᵢ(t):

$$p ( x ( t ) \vert {z}_{i} ( t ) ) \times p ( {z}_{i} ( t ) \vert x ( t ) ) p ( x ( t ) \vert \overline{z ( t - 1 )} )$$

where p(zᵢ(t)|x(t)) is taken from the sensor model 608 and p(x(t)| z̅(̅t̅−̅1̅)̅) is taken from the location model 602.

Before spending the energy to obtain zᵢ(t) with a location sensor 524, however, the selection module 520 must calculate eᵢ(t). Because eᵢ(t) must be calculated before obtaining zᵢ(t), the selection module 520 uses an estimate of the error, denoted [symbol] ). In one embodiment, to obtain this estimate, the selection module computes multiple p(x(t)|zᵢ(t)) for different possible zᵢ(t) that may be observed by a location sensing modality i and then takes a weighted average of the multiple variances computed from these p( ), based in part on the estimated distribution of the observations estimated from the estimated locations. In another embodiment, the error may be estimated by taking a combination of the variances of (zᵢ(t)|x(t)) at the predicted locations. These variances may be computed using p(zᵢ(t)|x(t)), for each predicted x(t). The combination of the variances may be computed as a weighted average where the weights are the probabilities of the different predicted locations x(t). The combination may also be computed as the maximum of these variances, indicating the worst case error for modality i. Other methods for predicting the error may also be employed. The weighted average produces an expected variance, [symbol] , which is used as a quantitative measure of the error performance of the location sensing modality i (i.e., the accuracy 512 of location sensing modality i).

As mentioned above, after calculating [symbol] for each available location sensing modality i, the selection module 520 compares the variance [symbol] to the square of the accuracy constraint 508/maximum tolerable error. The variance is compared to the square of the accuracy constraint 508 because the variance is the square of the standard deviation of the location sensing modality 510. For each location sensing modality 510 whose variance is less than the square of the accuracy constraint 508, the selection module 520 adds the location sensing modality 510 to the shortlist. Then, as mentioned, the selection module 520 selects the location sensing modality 510 associated with the least energy consumption as determined in view of the energy consumption characterizations 514 and the energy model 612. In other embodiments, an energy constraint may be used for an application in place of or in addition to the accuracy constraint 508. The mobile device 102 may then determine which location sensing modalities 510 are capable of meeting the energy constraint or a weighted sum or average of the energy constraint and accuracy constraint. The mobile device 102 could then select, for example, a location sensing modality 510 which meets the energy constraint and has the maximum accuracy or a location sensing modality 510 which meets the weighted sum or average and has a maximum or minimum value for that sum or average.

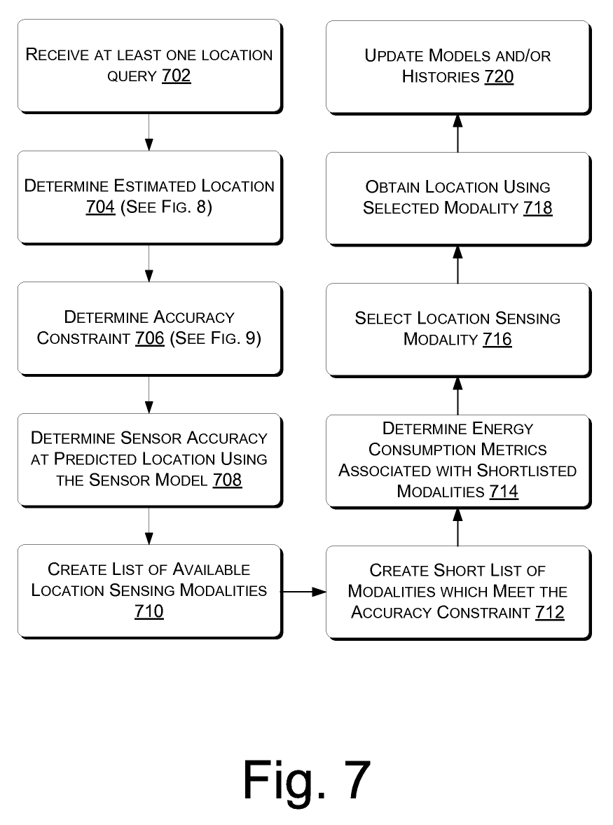

These selection module operations are further illustrated in FIG. 7 and described in greater detail below in reference to that figure.

### Sensor Data 614 and Location 616

In various embodiments, once the selection module 520 has selected the location sensing modality 510, the location sensing modality 510 is then used to access its associated location sensor 524 and to take a reading with that location sensor 524. The location sensor 524 then produces sensor data 614, which includes an observed location zᵢ(t), and may also include a measure of energy consumed taking the reading, and information noting sensor-specific data, such as the number of WiFi access points 112, cell towers 110, or Bluetooth™ device 114. This sensor data is then provided to past sensor data 610 to update the sensor model 608 and/or to the energy model 612 to update the energy model 612.

In various embodiments, the modules and data 504, such as a module of the location sensing modality 510, then utilizes the sensor data 614 to calculate the location 616 from the observed location zᵢ(t). The location 616 is represented as [symbol] which can be calculated using the following formula:

[symbol]

(t)=∫ₓx(t)p(x(t)|zᵢ(t))dx(t)

Where p(x(t)|zᵢ(t)) is the (posterior) probability of the true location being x(t) given all observations including sensor measured location zᵢ(t). This location 616 is then provided as a response to the at least one location query to one or more applications 506, for instance. The location 616 is also provided to user data 604 to update the user data.

### Example Operations

FIG. 7 is a flowchart view of example operations of a location sensing modality selection process, in accordance with various embodiments. As illustrated, a mobile device first receives at least one location query, block 702. As discussed above, location queries are received from one or more applications 506 of a mobile device 102. In other embodiments, location queries are received from other sources, such as external devices or applications.

The mobile device then determines an estimated location for itself, block 704. In some embodiments, the determining of the estimated location occurs independently of receiving the at least one location query—every t seconds, for example. In other embodiments the estimated location is determined in response to receiving the at least one location query. Also, as mentioned above, the estimated location is determined utilizing a location model 602, with reference to one or both of user data 604 and global data 606. The determining of the estimated location is illustrated further in FIG. 8 and described in greater detail below with regard to that figure.

In various embodiments, the mobile device then determines the accuracy constraint for the at least one location query, block 706. If multiple location queries are received, the mobile device determines an accuracy constraint, such as accuracy constraint 508, for each query and selects the accuracy constraint allowing least tolerable error (each accuracy constraint being a measure of a maximum tolerable error, as described above). The determining of the accuracy constraint is illustrated further in FIG. 9 and described in greater detail below with regard to that figure.

As is shown, the mobile device then compares the estimated location to the sensor model, block 708, to create a list of available location sensing modalities, block 710. As described above, a sensor model 608 includes probability distributions which indicate the quality of each location sensing modality 510 at the estimated location and whether each location sensing modality 510 is available. In various embodiments, the comparing, block 708, and the creating, block 710, are performed automatically, every t seconds, or are performed only in response to receiving at least one location query, block 702.

As illustrated, the mobile device then creates a shortlist of location sensing modalities, block 712, from the list of available location sensing modalities, the shortlisted location sensing modalities meeting the accuracy constraint 508. As described above, the creating, block 712, involves calculating a variance for each location sensing modality 510, the variance being the square of the standard deviation of the location sensing modality, and comparing the variance to the accuracy constraint 508, selecting only location sensing modalities 510 having variances that are less than a square of the accuracy constraint 508.

In various embodiments, the mobile device then determines an energy-consumption characterization associated with each of the shortlisted location sensing modalities, block 714. In some embodiments, the determining, block 714, is based on an energy model including energy consumptions associated with one or both of the estimated location and the location sensing modalities. The energy model may be the energy model 612, which was described above.

As shown, the mobile device then selects the location sensing modality which consumes the least energy, block 716, the energy consumed being defined by the energy consumption characterizations of the location sensing modalities. The selection, block 716, is described above in great detail with regard to selection module 520.

After selecting the location sensing modality, the mobile device then utilizes the location sensor associated with the selected location sensing modality to obtain a mobile device location, block 718. As mentioned above, the obtained location and other sensor data 614 are then used to calculate a location 616, which is then provided to the application(s) 506 posing the at least one location query.

In various embodiments, the obtained location (i.e., sensor data 614 and location 616) is then used to update one or more models and/or histories, block 720. As described above, the sensor data 614 is used to update one or both of the sensor model 608 and/or the energy model 612. Also, the location 616 is used to update the user data 604 location history.

FIG. 8 is a flowchart view of example operations of a location estimation process, in accordance with various embodiments. As illustrated, a mobile device determines an estimated location by first determining previous mobile device locations, block 802. As discussed above, this may involve using the most recently obtained locations in a Hidden Markov Model to better predict the estimated location.

In various embodiments, the mobile device then compares those previous locations to locations stored in a mobile device location history, block 804, such as user data 604.

If the previous locations are similar, block 806, to other previous locations in the mobile device location history for the same date/time/etc., then the mobile device determines the estimated location based on the mobile device location history, block 808.

If, on the other hand, the previous locations are not similar, block 806, from the other previous locations in the mobile device location history for the same date/time/etc., then the mobile device determines the estimated location based on a global location history, block 810, such as global data 606.

As described above, both determining 808 and 810 further involve creating a probability distribution based on the observed locations retrieved from the mobile device location history and/or global location history, and selecting the most probable location, based on the probability distribution, as the estimated location.

FIG. 9 is a flowchart view of example operations of an accuracy constraint determination process, in accordance with various embodiments. As illustrated, a mobile device determines an accuracy constraint by first determining the information associated with the at least one location query, such as locations of one or more entities associated with the at least one location query, block 902. As mentioned above, the locations of the entities are retrieved from local or remote storage, from yellow pages, or from the application or an application server.

As shown, the mobile device then derives the accuracy constraint based on distances between entity location and the estimated location described in FIGS. 7 and 8, block 904. As described above, the mobile device determines the nearest k entities to the mobile device 102, calculates radii between the entity locations and estimated location, and takes the difference between those radii divided, for example, by two as the derived accuracy constraint.

In various embodiments, the mobile device then selects the max of the derived accuracy constraint and a threshold as the accuracy constraint, block 906. Further, in some embodiments, the mobile device even facilitates a mobile device 102 user in defining the threshold, block 908, including defining multiple, application-specific thresholds. Also, the threshold is a pre-determined value, calculated in the manner described above.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
determining, by a mobile device, an accuracy constraint associated with at least one location query; and
selecting, by the mobile device, a location sensing modality of one or more location sensing modalities, each of the one or more location sensing modalities being associated with an energy consumption characterization, and the selecting being based at least in part on the accuracy constraint and at least in part on the energy consumption characterizations of the one or more location sensing modalities.

2. The method of claim 1, wherein the determining comprises deriving the accuracy constraint based on information associated with the at least one location query.

3. The method of claim 2, wherein the information includes locations of one or more other entities.

4. The method of claim 1, wherein the at least one location query is associated with at least one application of the mobile device.

5. The method of claim 1, wherein the accuracy constraint is a maximum location error determined based at least in part on locations of one or more other entities and at least in part on an estimated location of the mobile device.

6. The method of claim 5, wherein the maximum location error cannot be less than an error threshold.

7. The method of claim 6, further comprising facilitating a user in setting different error thresholds for different applications based on factors including user privacy or energy consumption.

8. The method of claim 1, further comprising determining an estimated location of the mobile device based at least in part on previous mobile device locations and at least in part on one or both of a mobile device location history and a global location history.

9. The method of claim 8, wherein the determining of the estimated location is further based at least in part on global location data.

10. The method of claim 8, further comprising comparing the estimated location to a sensor model, the sensor model including a list of location sensing modalities available at the estimated location and an accuracy of each location sensing modality.

11. The method of claim 10, further comprising creating a list of available location sensing modalities based at least in part on the comparing.

12. The method of claim 11, further comprising creating a shortlist including the one or more location sensing modalities based on the list of available location sensing modalities, each location sensing modality on the shortlist having an accuracy that meets the accuracy constraint.

13. The method of claim 1, further comprising determining the energy consumption characterizations based on an energy model including energy consumptions associated with one or both of an estimated location and location sensing modalities.

14. The method of claim 1, further comprising obtaining a mobile device location using the selected location sensing modality.

15. The method of claim 14, further comprising updating one or more models and/or histories with the obtained location.

16. A mobile device comprising:
a processor;
a storage medium;
a battery;
a plurality of location sensors that can be used to locate the mobile device, individual location sensors consuming different levels of power from the battery during use and having varying degrees of accuracy in locating the mobile device; and
programming instructions stored on the storage medium that, when executed by the processor, perform operations including:
deriving an accuracy constraint based on information associated with at least one location query;
selecting a location sensing modality corresponding to a certain location sensor from among the plurality of location sensors, wherein the certain location sensor consumes the least amount of power as compared to other location sensors while still providing a degree of accuracy that satisfies the accuracy constraint; and
obtaining a location of the mobile device using the certain location sensor.

17. The mobile device of claim 16, wherein the programming instructions, when executed, further perform operations including:
creating a list of available location sensors based at least in part on one or more of a location model and a sensor model; and
creating a shortlist including the plurality of location sensors based on the list of available location sensors, each location sensor on the shortlist having a degree of accuracy that meets the accuracy constraint.

18. The mobile device of claim 16, wherein the programming instructions, when executed, further perform operations including determining the amount of power consumed based on an energy model including power consumptions associated with one or both of an estimated location and location sensors.

19. A method comprising:
receiving, by a mobile device, at least one location query;
determining, by the mobile device, an accuracy constraint associated with the at least one location query, the determining including deriving the accuracy constraint based on locations of one or more entities associated with the at least one location query;
creating, by the mobile device, a list of available location sensing modalities based at least in part on one or more of a location model and a sensor model;
creating, by the mobile device, a shortlist of one or more location sensing modalities based on the list of available location sensing modalities, each location sensing modality on the shortlist having an accuracy that meets the accuracy constraint;
selecting, by the mobile device, a location sensing modality from the shortlist of the one or more location sensing modalities, each location sensing modality of the shortlist of the one or more location sensing modalities being associated with an energy consumption characterization, and the selecting being based at least in part on the accuracy constraint and the energy consumption characterizations; and
obtaining, by the mobile device, a mobile device location using the selected location sensing modality.

20. The method of claim 19, further comprising determining the energy consumption characterizations based on an energy model including energy consumptions associated with one or both of an estimated location and location sensing modalities.
